(19) United States
(12) Patent Application Publication
(10) Pub. No.: US 2005/0143768 A1
(43) Pub. Date: Jun. 30, 2005

(54) Sleeved guidewire system method of use

(76) Inventor: Samuel Shiber, Manchester, NH (US)

Correspondence Address: SAMUEL SHIBER, 365 KEARNEY CR, MANCHESTER, NH, 03104, US

(21) Appl. No.: 11/071,140

(22) Filed: Mar. 3, 2005

Related U.S. Application Data
(63) Continuation-in-part of application No. 10/937,134, filed on Sep. 9, 2004.
(63) Continuation-in-part of application No. 10/620,740, filed on Jul. 16, 2003.
(63) Continuation-in-part of application No. 10/463,189, filed on Jun. 17, 2003.

(51) Int. Cl. A61D 1/02

(52) U.S. Cl. 606/159

(57) ABSTRACT

A method of treating a vessel containing an obstruction with a system that is slidable and rotatable over a flexible pilot wire, the system having a flexible casing with a distal section in the form of a helical wire and a coupling means connected to the casing for moving and rotating the casing over the pilot wire, and a flexible sleeve in which the casing is slidably and rotatably disposed, the method comprising the steps of: inserting a pilot wire and a casing into the vessel; advancing, and rotating as needed, the coupling means and casing over the pilot wire into the vessel and engaging the helical wire with the obstruction; advancing a distal end of the sleeve over the casing into the vessel and applying negative pressure to the sleeve while simultaneously withdrawing the casing from the vessel.

### CROSS REFERENCE TO RELATED APPLICATIONS

This application is a continuation-in-part of my co-pending applications Ser. No. 10/937134 that was filed on Sep. 9, 2004 (CT24), Ser. No. 10/620740 that was filed on Jul. 16, 2003 (CT23) and Ser. No. 10/463189 that was filed on Jun. 17, 2003 (CT22).

All of the above applications are being incorporated herein by reference.

### BACKGROUND AND OBJECTIVES OF THE INVENTION

With age a large percentage of the population develops atherosclerotic and/or thrombotic obstructions resulting in partial or total obstructions of blood vessels in various parts of the human anatomy. Such obstructions are often treated with thrombectomy, angioplasty or atherectomy catheters and a common preparatory step to such treatments is inserting a guidewire through the obstruction.

An objective of the present invention is to provide a simple and reliable method of treating an obstructed vessel with a flexible sleeved guidewire system capable of crossing tortuous vasculature and obstructions and/or removing the obstruction.

The above and other objectives of the invention will become apparent from the following discussion and the accompanying drawings.

### BRIEF DESCRIPTION OF THE FIGURES

FIG. 1 schematically shows a side view of a flexible sleeved guidewire system inserted percutaneously at a patient's groin area, through his arterial system, into the patient's obstructed coronary artery;

FIG. 2 shows an enlarged proximal portion of the system shown in FIG.1;

FIGS. 3 and 3′ shows an enlarged side and end views, respectively, of the distal portion of the system shown in FIG. 1;

FIG. 4 shows a side view of a casing disposed over a guidewire;

FIGS. 5 and 5′ show a side and distal end views, respectively, of a system with a flexible sleeve having an inflatable asymmetrical distal chamber (i.e., the chamber being located in the vicinity of the distal end of the sleeve); and

FIGS. 6 and 6′ show a side and distal end views, respectively, of a system with a flexible sleeve having an inflatable symmetrical distal chamber.

### DETAILED DESCRIPTION OF THE DRAWINGS

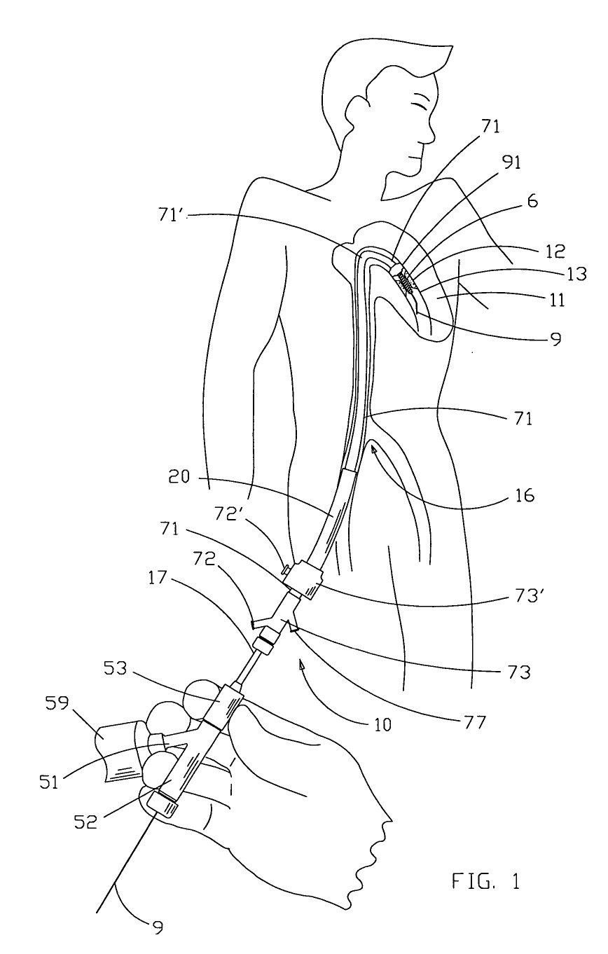

FIGS. 1, 2, 3, 3′, 4, 6 and 6′ show a first embodiment of a flexible sleeved guidewire system 10, for extracting an obstruction from within a patient's vessel, made of elongated components that are rotatable and slidable one relative to the other (the components' ends that go further into the vessel are referred to as “distal” and their other ends are referred to as “proximal”). The system is shown crossing an obstruction 12 located in a patient's coronary vessel 13 serving the heart 11 (the patient's anatomy and the system are illustrated schematically and are not drawn to scale).

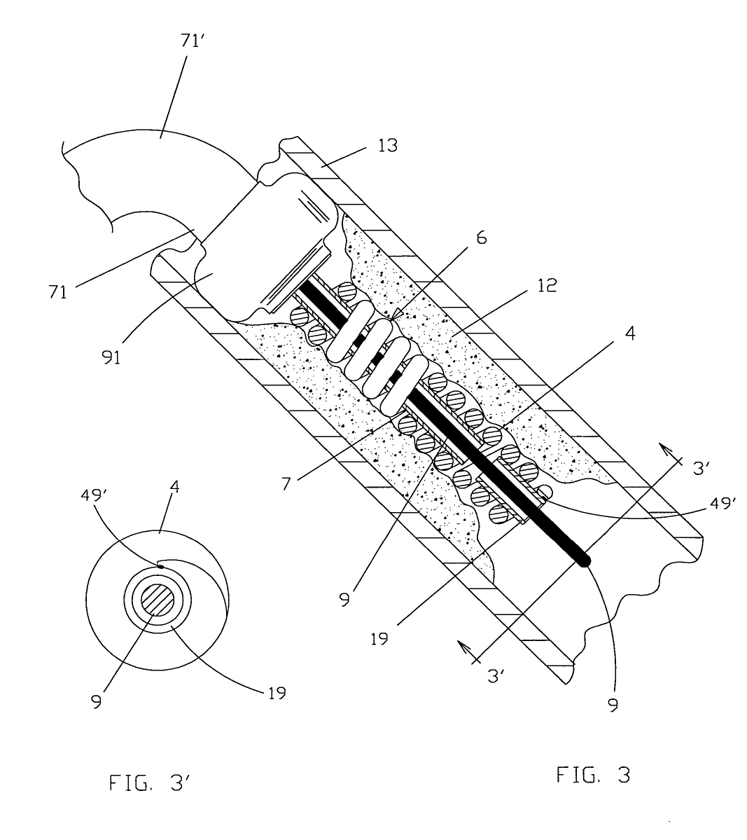

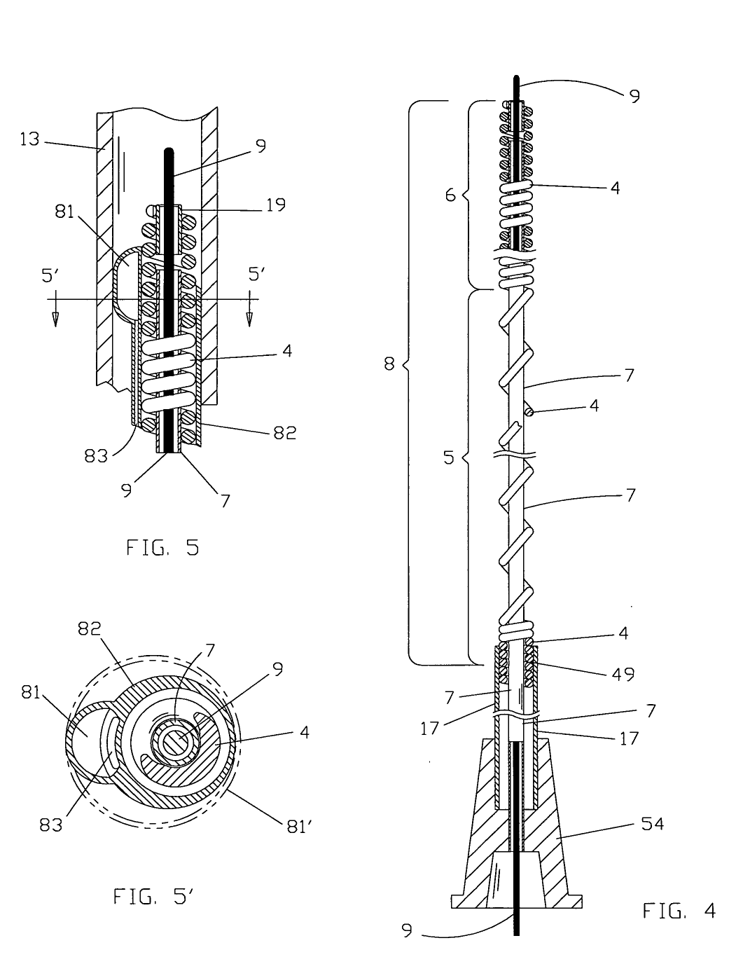

The system 10 is slidable and rotatable over a flexible pilot wire 9 and it comprises a flexible tubular casing 8 (note FIG. 4), slidable and rotatable over the pilot wire (the pilot wire can be a standard guidewire commercially available from numerous companies, (e.g.: Boston Scientific, Natick, Mass.; Cook, Bloomington, Ind., Terumo Medical, Somerset, N.J.; Lake Region Mfg., Chaska, Minn.; Medtronic, Minneapolis, Minn.). At least a distal portion of the casing 6 is a helical wire that is preferably gated at its distal end by a tube section 19 that is secured to the helical wire by a weld 49′ (note FIGS. 3 and 3′). A coupling means, in the form of a tube 17, is connected to the casing by a weld 49 (note FIG. 4) for rotating and linearly moving the casing and a shield 7 over the pilot wire.

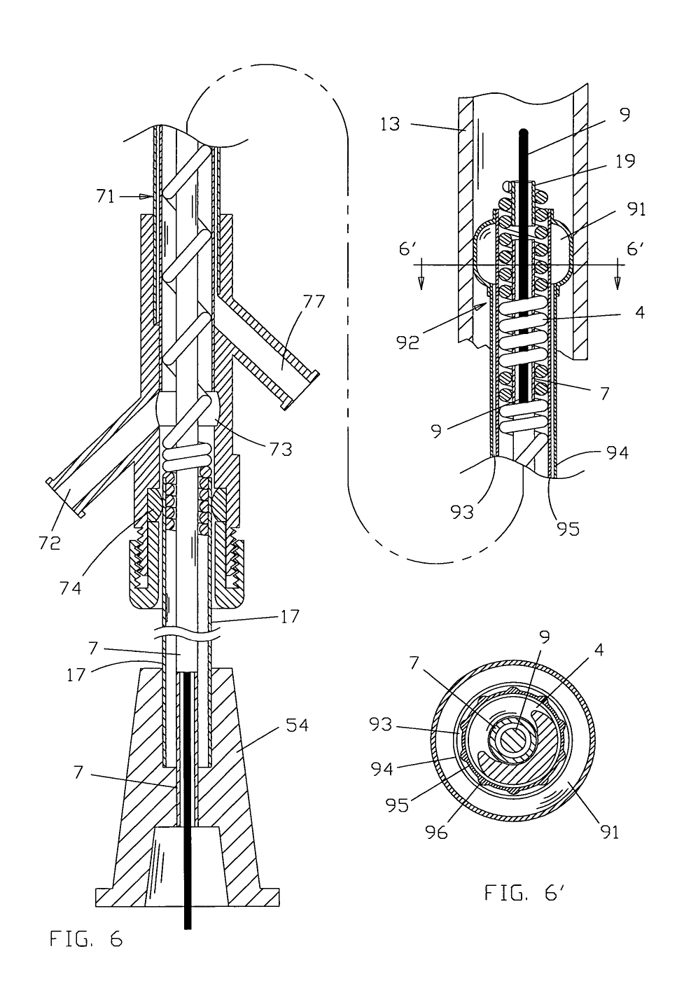

The casing is moveable and rotatable in a sleeve 71 that guides it through the arterial system to the obstruction 12. The sleeve is preferably also rotatable over the casing so that it can be advanced over it with less longitudinal frictional resistance. Alternatively, the distal end section of the sleeve can be pre-curved, as shown in FIG. 1 and marked 71′, to direct the distal end of the system into a specific vessel and/or selectively bias it inside the vessel. An external port 72 that is connectable, for example, to a syringe (not shown) is connected to the flexible sleeve through an annular chamber 73 that is attached to the proximal end of the sleeve. The chamber is equipped with a seal 74 (note FIG. 6) that seals around a smooth outer surface of the tube 17. The sleeve 71 can be inserted into the vasculature directly or through a standard introducer 20 having a port 72′ that is also connectable, for example, to a syringe (not shown), a chamber 73′ and a seal 74′ that seals on the outer surface of sleeve 71 (standard introducers are sold by numerous companies, e.g.: Boston Scientific, Natick, Mass.; Cook, Bloomington, Ind.).

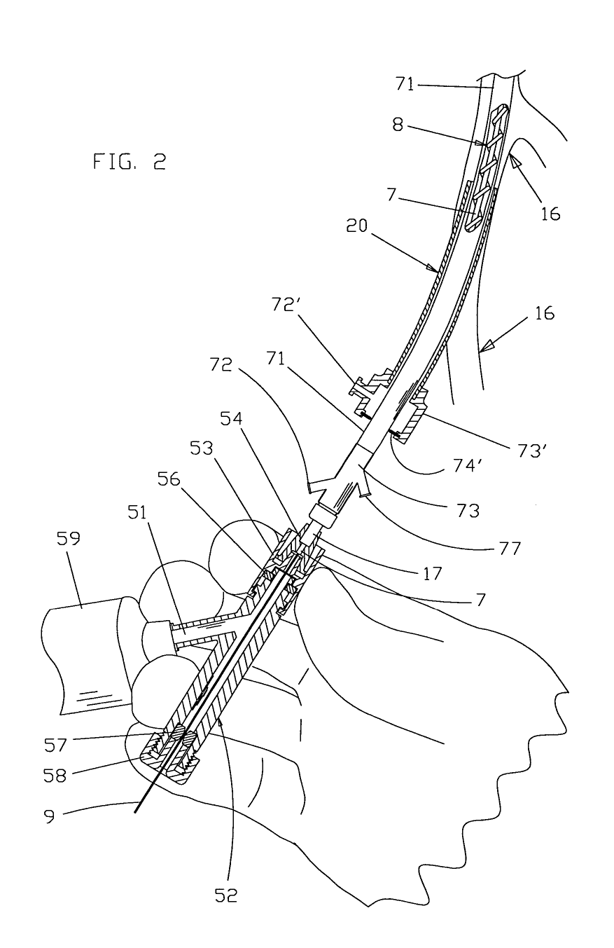

The optional internal tubular pilot wire shield 7 has an open distal end (note FIG. 3) and a proximal end (note FIG. 4) that is affixed (e.g., bonded) to a luer fitting 54 which is also affixed to a proximal end of the tube 17. The luer fitting 54 mechanically and hydraulically couples with a mating luer fitting formed in a rotatable portion 53 of rotating Y-connector 52 (such rotating Y-connectors are sold by numerous companies, e.g.: EV3, Plymouth, Minn.). This establishes a mechanical connection between the casing 8 and the shield 7 to the rotating Y-connector 52 as well as a hydraulically connects the shield to an external port 51 incorporated in the rotary Y-connector (note FIG. 2) to which a syringe 59 may be connected for flushing the shield or delivering to the vessel 12 fluid (e.g., saline solution, radio-opaque fluid, drugs). A seal 56 prevents leakage through the rotary connection.

At its proximal end the Y-connector is equipped with a compression-seal 57, the internal diameter of which decreases in response to tightening of a threaded cap 58 which reduces the length of the seal causing it to elastically deform and close the opening around the pilot wire 9, or in the absence of a pilot wire, to shut the proximal end of the Y-connector.

As illustrated in FIGS. 1 and 2, the system can be held by a single hand while using a couple of fingers (e.g., the thumb and index finger) to rotate the rotating part of the luer fitting 53 and thereby to rotate the casing 8.

FIG. 3. shows the distal end of the system, wherein the distal portion of the casing is gated by the tube section 19 that is affixed to the casing by the weld 49′. The distal end of the wire 4 is ground down (note FIG. 3′) to form a smooth inclined plane and reduce the likelihood of trauma to the vessel 13.

FIG. 4 shows an overview of the casing 8 that comprises a distal section 6 in the form of closely wound coils and a midsection 5 in the form of distantly spaced coils. Both sections 6 and 5 are wound from a continuous wire 4 which enhances the casing's integrity. The closely wound coils provide enhanced flexibility whereas the distantly spaced coils provide enhanced torsional and longitudinal rigidity thereby reducing the angular and linear elastic deformation between the distal and proximal ends of the casing under torque and linear loading, respectively. Optionally the wire 4 that forms the proximal end of the casing can also be wound to form few closely wound coils to improve its weldment 49 to the tube 17. As shown in FIGS. 3 to 6, the wire 4 has a round cross-section, however, the casing can be alternatively wound from a wire with another cross-section (e.g., a flattened cross-section). [HOW ABOUT USING TAPERED ROUND WIRE TO AFFECT DISTAL FLEXIBILITY?]

The tube 17 essentially serves as an extension of the casing's proximal end, and it has a smooth outside surface that is suitable for the seal 74 to seal against while the tube 17 is rotated and linearly moved through it. The system can be inserted directly through the introducer 20, in which case the seal 74′ provides the sealing around the tube 17.

FIGS. 5 and 5′ show cross-sectioned side and end views, respectively, of a biasing means in the form of an asymmetrical inflatable distal chamber 81 formed close to the distal end of a flexible sleeve 82 which, when inflated through a channel 83 formed in the sleeve's wall, bears against the vessel's wall, eccentrically biasing the flexible sleeve in the vessel. When deflated, the chamber conforms to the sleeve to minimize interference with its insertion into the vessel. Alternatively, the chamber can be shaped as an asymmetrical toroidal inflatable chamber 81′ as shown in FIG. 5′ by interrupted lines. This chamber, when inflated, establishes peripheral contact with the vessel's wall and thereby blocks blood flow between the sleeve and the vessel's wall, as well as eccentrically biases the sleeve

FIGS. 6 and 6′ show cross-sectioned side and end views, respectively, of a biasing means in the form of a symmetrical inflatable distal chamber 91 formed close to the distal end of a flexible sleeve 92 which, when inflated for example by a syringe (not shown) through a port 77 connected to a channel 93 formed between the sleeve's two concentric outer and inner layers 94 and 95, respectively, bears against the vessel's wall while centering the biasing sleeve in the vessel. Optional longitudinal ridges 96 (that can be extruded as a part of the inner layer) scaffold the channel 93. When deflated, the chamber conforms to the sleeve to minimize interference with its insertion into the vessel.

### Operation

In general, the method for extracting an obstruction from within a patient's vessel with a system that comprises a flexible casing having a distal section in the form of a helical wire, and a flexible sleeve in which the casing is slidably and rotatably disposed, comprises the following steps:
advancing, and rotating as needed, the casing over a pilot wire into the vessel and engaging the helical wire with the obstruction;
placing a distal end of the sleeve in the vessel and applying negative pressure to the sleeve while simultaneously withdrawing the helical wire into the sleeve.

More specifically, the embodiments of the Sleeved Guidewire System can be used for extracting an obstruction from within a patient's vessel using the following methods:

Inserting the pilot wire into the vessel.

Advancing the casing over the pilot wire into the vessel, rotating the casing as needed to overcome longitudinal friction between the casing and the pilot wire that is disposed in the casing and/or the longitudinal friction between the casing and its surroundings, i.e., the sleeve and vessels through which the casing is being advanced, and engage the casing with the obstruction. When the casing is rotated in a direction that the coils are wound, the rotation generates a pulling force that assists the casing's advancement towards the obstruction and preferably threads the helical wire into the obstruction. Threading, rather than simply pushing, the helical wire into the obstruction better engages the obstruction and reduces the likelihood of releasing obstruction material downstream that can causing distal embolization. The pulling force, generated by the rotation at the distal section of the casing, and the reduced longitudinal friction are significant because in order to deliver to the distal end of the casing the same amount of force by pushing the casing's proximal end through a tortuous path (as commonly are the paths through the coronary and intracranial vasculatures), a larger force would be required. A large force is likely to be more injurious to the vessels and would tend to buckle the casing. Thus, the reduced longitudinal friction and the distal pulling force enable the casing to move through tortuous vasculature and reach vessels that would be otherwise harder to reach or inaccessible.

In the process of inserting the pilot wire into the vessel, the flexible distal tip of the pilot wire may encounter a hard spot (e.g., a total occlusion) that it cannot pass in which case the distal tip of the casing can be advanced to provide support and enhance the pushability of the pilot wire. Optionally the end of the helical wire may be advanced, past the distal tip of the pilot wire, into and/or through such a hard spot and thereafter, the tip of the pilot wire may be advanced past the distal tip of the casing in a leapfrog-like manner. Likewise, the sleeve may be temporarily advanced ahead of or past the distal end of the casing.

Advancing the flexible sleeve over the casing and optionally rotating it as needed to overcome longitudinal friction with the casing as well as the longitudinal friction between the sleeve and its surroundings, e.g., an introducer (if one is used) and the vessels through which the sleeve is being advanced. The reduced longitudinal friction assists the sleeve to move through tortuous vasculature.

Inflating the distal chamber (where the sleeve is equipped with an inflatable chamber), thereby blocking flow between the sleeve and the vessel and reducing the likelihood of obstruction pieces being released downstream, and
applying negative pressure to the sleeve while simultaneously withdrawing the casing from the vessel to mechanically pull the obstruction into the sleeve together with the aspiration action of the negative pressure. This combination of hydraulic and mechanical forces is more effective than either force alone and it is synergistic since the aspiration draws the obstruction material to the open distal end of the sleeve and the casing mechanically pulls it into the sleeve allowing additional material to be aspirated.

It is also possible to continue and rotate the casing, after it has been threaded across the obstruction and as it is being withdrawn, to increase the helical wire's proximal conveyance action, especially when working in an obstruction with a slurry-like consistency such as fresh blood clots.

The sequence of inserting the system's components into the vessel may be varied and steps may be combined to streamline the procedure or steps may be added to improve the procedure and customize it to the location and characteristics of an obstruction in an individual patient and to the working preferences of the medical staff. For example, the system may be introduced percutaneously through a standard guiding catheter (standard guiding catheters are commercially available from numerous companies, e.g.: Boston Scientific, Natick, Mass.; Cook, Bloomington, Ind.) and/or an introducer of various lengths or guiding catheter may serve as a sleeve. If the distal end section of the pilot wire is inserted into the vessel ahead of the casing it assists in guiding the casing into the vessel. I If a portion of the pilot wire is inserted into the vessel distal to the casing it provides a lever arm to angularly align the casing with the vessel and once the casing is in the vessel it provides a lever arm to angularly align the sleeve with the vessel.

The system can also be introduced intra-operatively, i.e., by accessing vasculature or vessel directly while it is surgically exposed. Further, the pilot wire and the casing can be pre-nested before they are inserted into the vessel to streamline the procedure. Further, a system according to the present invention can have different diameters and lengths depending on the size and site of the vessel that it is intended for and on whether the system is to be used percutaneously or intra-operatively. For example, a system that is intended to be introduced percutaneously at the groin area for crossing an obstruction in a coronary vessel preferably utilizes a pilot wire in the form of a commercially available guidewire with a 0.014″ (″ denotes inches) diameter and a length of 120″ with a casing having an internal diameter of 0.020″, an outside diameter of 0.045″ and a length of 50″. The distal portion of the casing can be 10″ long, the midsection 30″ long and the tube 17 can be 10″ long and the sleeve length maybe approximately 40″. If the system utilizes a larger diameter pilot wire, such as an 0.035″ guidewire, the casing diameters can be increased accordingly. If the system is intended for use in peripheral (non-coronary) blood vessels or where direct access to the vessel is gained surgically (intra-operatively), the system can be shorter.

As illustrated above, variations, modifications, and substitutions can made within the spirit of the invention and the scope of the following claims.

1. A method for extracting an obstruction from within a patient's vessel with a system that comprises a flexible sleeve having a distal end disposed in said vessel and a flexible casing rotatable and slidable over a pilot wire and being rotatably and slidably disposed in said sleeve, said casing having a distal section in the form of a helical wire, said method comprising the following steps:
advancing, and rotating as needed, said casing over a pilot wire into the vessel and engaging said helical wire with said obstruction; and
applying negative pressure to said sleeve while simultaneously withdrawing said helical wire into said sleeve.

2. A method for extracting an obstruction from within a patient's vessel with a system that comprises a flexible sleeve having a distal end disposed in said vessel and a flexible casing rotatable and slidable over a pilot wire and being rotatably and slidably disposed in said sleeve, said casing having a distal section in the form of a helical wire that is gated at its distal end, said method comprising the following steps:
advancing, and rotating as needed, said casing over a pilot wire into the vessel and engaging said helical wire with said obstruction; and
applying negative pressure to said sleeve while simultaneously withdrawing said helical wire into said sleeve.

3. A method for extracting an obstruction from within a patient's vessel with a system that comprises a flexible sleeve having a distal end disposed in said vessel and a flexible casing rotatable and slidable over a pilot wire and being rotatably and slidably disposed in said sleeve, said casing containing a tubular shield and having a distal section in the form of a helical wire, said method comprising the following steps:
advancing, and rotating as needed, said casing over a pilot wire into the vessel and engaging said helical wire with said obstruction; and
applying negative pressure to said sleeve while simultaneously withdrawing said helical wire into said sleeve.

4. A method for extracting an obstruction from within a patient's vessel with a system that comprises a flexible sleeve having a selectively inflatable distal chamber for blocking flow between the sleeve and the vessel, and a flexible casing rotatable and slidable over a pilot wire and being rotatably and slidably disposed in said sleeve, said casing having a distal section in the form of a helical wire, said method comprising the following steps:
advancing, and rotating as needed, said casing over a pilot wire into the vessel and engaging said helical wire with said obstruction; and
applying negative pressure to said sleeve while simultaneously withdrawing said helical wire into said sleeve.

5. A method for extracting an obstruction from within a patient's vessel with a system that comprises a flexible sleeve having a selectively inflatable distal chamber for blocking flow between the sleeve and the vessel, and a flexible casing rotatable and slidable over a pilot wire and being rotatably and slidably disposed in said sleeve, said casing having a distal section in the form of a helical wire that is gated at its distal end, said method comprising the following steps:
advancing, and rotating as needed, said casing over a pilot wire into the vessel and engaging said helical wire with said obstruction; and
applying negative pressure to said sleeve while simultaneously withdrawing said helical wire into said sleeve.

6. A method for extracting an obstruction from within a patient's vessel with a system that comprises a flexible sleeve having a selectively inflatable distal chamber for blocking flow between the sleeve and the vessel, and a flexible casing rotatable and slidable over a pilot wire and being rotatably and slidably disposed in said sleeve, said casing containing a tubular shield and having a distal section in the form of a helical wire, said method comprising the following steps:
advancing, and rotating as needed, said casing over a pilot wire into the vessel and engaging said helical wire with said obstruction; and
applying negative pressure to said sleeve while simultaneously withdrawing said helical wire into said sleeve.

7. As in claim 3, wherein fluid is delivered through the distal end of the shield.

8. As in claim 6, wherein fluid is delivered through the distal end of the shield.

9. As in claim 3, wherein radio-opaque fluid is delivered through the distal end of the shield.

10. As in claim 6, wherein radio-opaque fluid is delivered through the distal end of the shield.

11. As in claim 1, wherein a portion of said pilot wire is inserted distally to said casing, into said vessel, thereby providing a lever arm to angularly align said casing with the vessel.

12. As in claim 2, wherein a portion of said pilot wire is inserted distally to said casing, into said vessel, thereby providing a lever arm to angularly align said casing with the vessel.

13. As in claim 3, wherein a portion of said pilot wire is inserted distally to said casing, into said vessel, thereby providing a lever arm to angularly align said casing with the vessel.

14. As in claim 4, wherein a portion of said pilot wire is inserted distally to said casing, into said vessel, thereby providing a lever arm to angularly align said casing with the vessel.

15. As in claim 5, wherein a portion of said pilot wire is inserted distally to said casing, into said vessel, thereby providing a lever arm to angularly align said casing with the vessel.

16. As in claim 6, wherein a portion of said pilot wire is inserted distally to said casing, into said vessel, thereby providing a lever arm to angularly align said casing with the vessel.

17. As in claim 1, wherein a portion of said casing is inserted distally to said sleeve, into said vessel, thereby providing a lever arm to angularly align said sleeve with the vessel.

18. As in claim 2, wherein a portion of said casing is inserted distally to said sleeve, into said vessel, thereby providing a lever arm to angularly align said sleeve with the vessel.

19. As in claim 3, wherein a portion of said casing is inserted distally to said sleeve, into said vessel, thereby providing a lever arm to angularly align said sleeve with the vessel.

20. As in claim 4, wherein a portion of said casing is inserted distally to said sleeve, into said vessel, thereby providing a lever arm to angularly align said sleeve with the vessel.

21. As in claim 5, wherein a portion of said casing is inserted distally to said sleeve, into said vessel, thereby providing a lever arm to angularly align said sleeve with the vessel.

22. As in claim 6, wherein a portion of said casing is inserted distally to said sleeve, into said vessel, thereby providing a lever arm to angularly align said sleeve with the vessel.
